(19) United States
(12) Patent Application Publication
(10) Pub. No.: US 2013/0107859 A1
(43) Pub. Date: May 2, 2013

(54) AVOIDING VOICE OVER INTERNET PROTOCOL (VoIP) PACKET LOSS DUE TO INTER-RADIO ACCESS TECHNOLOGY (RAT) HANDOVER

(71) Applicants: Guangming Shi, San Diego, CA (US); Tom Chin, San Diego, CA (US); Kuo-Chun Lee, San Diego, CA (US)

(72) Inventors: Guangming Shi, San Diego, CA (US); Tom Chin, San Diego, CA (US); Kuo-Chun Lee, San Diego, CA (US)

(73) Assignee: QUALCOMM Incorporated, San Diego, CA (US)

(21) Appl. No.: 13/283,377

(22) Filed: Oct. 27, 2011

(51) Int. Cl. H04W 36/00; H04B 7/208; H04B 7/216

(52) U.S. Cl. 370/331

(57) ABSTRACT

Aspects of the present disclosure provide methods for a multi-mode mobile station to continue to receive data from a first radio access technology (RAT) after initiating handover from the first RAT to a second RAT. According to aspects, a mobile station may use first and second receive hardware resources to avoid downlink packet loss during inter-RAT handover.

### BACKGROUND

1. Field

Certain aspects of the present disclosure generally relate to wireless communication and, more particularly, continuing to receive data from a first radio access technology (RAT) after initiating a handover from the first RAT to a second RAT.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is LTE. LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

Orthogonal frequency-division multiplexing (OFDM) and orthogonal frequency division multiple access (OFDMA) wireless communication systems under IEEE 802.16 use a network of base stations to communicate with wireless devices (i.e., mobile stations) registered for services in the systems based on the orthogonality of frequencies of multiple subcarriers and can be implemented to achieve a number of technical advantages for wideband wireless communications, such as resistance to multipath fading and interference. Each base station (BS) emits and receives radio frequency (RF) signals that convey data to and from the mobile stations. For various reasons, such as a mobile station (MS) moving away from the area covered by one base station and entering the area covered by another, a handover (also known as a handoff) may be performed to transfer communication services (e.g., an ongoing call or data session) from one base station to another.

In some cases, a mobile station (MS) may support multiple radio access technologies (RATs). Such a “multi-mode” MS may be required to perform “inter-RAT” handovers, between different RATs.

The capability to perform inter-RAT handovers may provide a broader coverage area for an MS. Unfortunately, data continuity is typically lost when performing an inter-RAT handover. In other words, a data connection maintained in a first RAT prior to the handover is typically lost during the handover and a new connection must be established in the second RAT. This loss of data continuity may result in service interruption and a less than ideal user experience.

### SUMMARY

In an aspect of the disclosure, a method for wireless communication is provided. The method generally includes initiating handover to a second radio access technology (RAT), while communicating with a first RAT, and continuing to receive data, at a mobile station, from the first RAT after initiating the handover.

In an aspect of the disclosure, an apparatus for wireless communication is provided. The apparatus generally includes means for initiating handover to a second radio access technology (RAT), while communicating with a first RAT, and means for continuing to receive data, at a mobile station, from the first RAT after initiating the handover.

In an aspect of the disclosure, an apparatus for wireless communication is provided. The apparatus generally includes at least one processor and a memory coupled to the at least one processor. The at least one processor is generally configured to initiate handover to a second radio access technology (RAT), while communicating with a first RAT, and continue to receive data, at a mobile station, from the first RAT after initiating the handover.

In an aspect of the disclosure, a computer-program product for wireless communication is provided. The computer-program product generally includes a non-transitory computer-readable medium having code stored thereon. The code is generally executable by one or more processors for initiating handover to a second radio access technology (RAT), while communicating with a first RAT, and continuing to receive data, at a mobile station, from the first RAT after initiating the handover.

### BRIEF DESCRIPTION OF THE DRAWINGS

So that the manner in which the above recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain aspects of the present disclosure.

FIG. 2 illustrates various components that may be utilized in a wireless device, in accordance with certain aspects of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology, in accordance with certain aspects of the present disclosure.

FIG. 4 illustrates example operations which may be performed, for example, by a mobile station, in accordance with certain aspects of the present disclosure.

FIG. 5 illustrates an example hardware setup with message tunnel for handover without HARQ, in accordance with certain aspects of the present disclosure.

FIG. 6 illustrates an example hardware setup with message tunnel for handover with HARQ, in accordance with certain aspects of the present disclosure.

FIG. 7 illustrates an example hardware setup without message tunnel for handover without HARQ, in accordance with certain aspects of the present disclosure.

FIG. 8 illustrates an example hardware setup without message tunnel for handover with HARQ, in accordance with certain aspects of the present disclosure.

### DETAILED DESCRIPTION

Certain aspects of the present disclosure provide methods for a mobile station to initiate handover to a second radio access technology (RAT), while communicating with a first RAT, and continuing to receive data from the first RAT after initiating the handover to the second RAT.

### An Example Wireless Communication System

The methods and apparatus of the present disclosure may be utilized in a broadband wireless communication system. The term “broadband wireless” refers to technology that provides wireless, voice, Internet, and/or data network access over a given area.

WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX offers the full mobility of cellular networks at broadband speeds.

Mobile WiMAX is based on OFDM (orthogonal frequency-division multiplexing) and OFDMA (orthogonal frequency division multiple access) technology. OFDM is a digital multi-carrier modulation technique that has recently found wide adoption in a variety of high-data-rate communication systems. With OFDM, a transmit bit stream is divided into multiple lower-rate substreams. Each substream is modulated with one of multiple orthogonal subcarriers and sent over one of a plurality of parallel subchannels. OFDMA is a multiple access technique in which users are assigned subcarriers in different time slots. OFDMA is a flexible multiple-access technique that can accommodate many users with widely varying applications, data rates, and quality of service requirements.

The rapid growth in wireless internets and communications has led to an increasing demand for high data rate in the field of wireless communications services. OFDM/OFDMA systems are today regarded as one of the most promising research areas and as a key technology for the next generation of wireless communications. This is due to the fact that OFDM/OFDMA modulation schemes can provide many advantages such as modulation efficiency, spectrum efficiency, flexibility, and strong multipath immunity over conventional single carrier modulation schemes.

IEEE 802.16x is an emerging standard organization to define an air interface for fixed and mobile broadband wireless access (BWA) systems. IEEE 802.16x approved “IEEE P802.16-REVd/D5-2004” in May 2004 for fixed BWA systems and published “IEEE P802.16e/D12 October 2005” in October 2005 for mobile BWA systems. Those two standards defined four different physical layers (PHYs) and one media access control (MAC) layer. The OFDM and OFDMA physical layer of the four physical layers are the most popular in the fixed and mobile BWA areas respectively.

As those skilled in the art will readily appreciate from the detailed description to follow, the various concepts presented herein are well suited for WiMax applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), LTE, IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

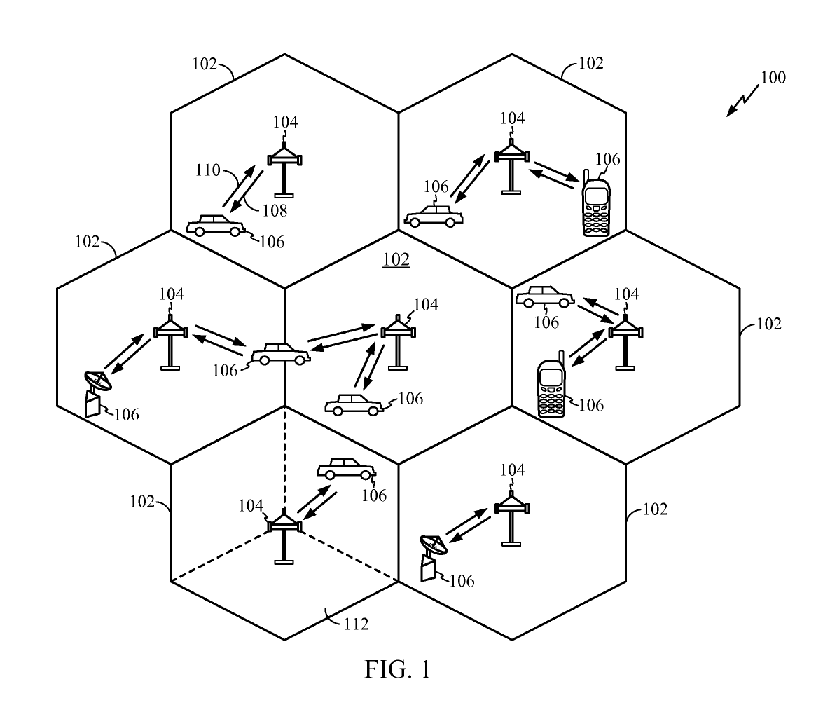

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers (PCs), etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

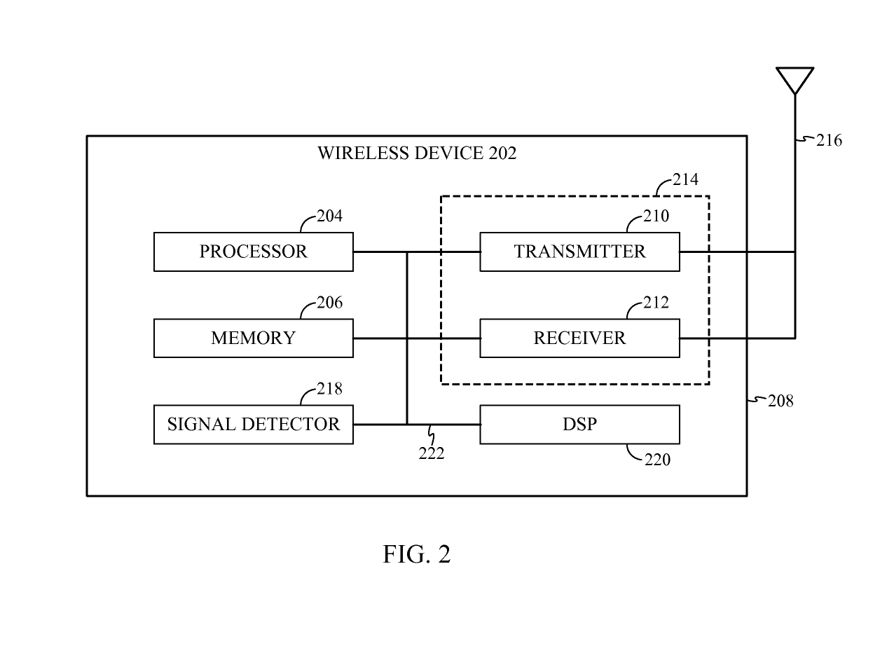

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

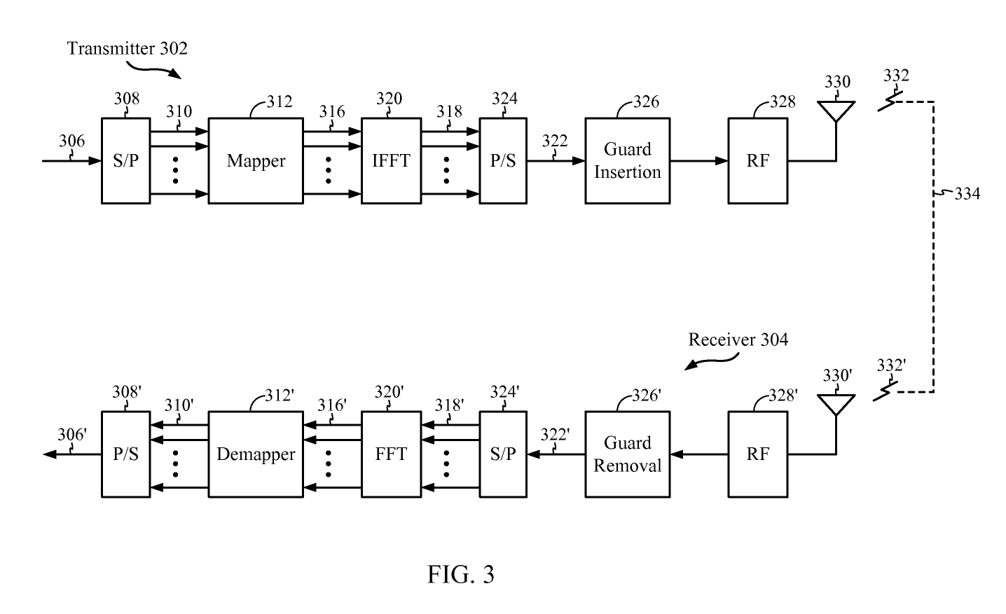

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

### Avoiding VoIP Packet Loss Due to Inter-Rat Handover

Aspects of the present disclosure provide techniques that may help reduce data packet loss when performing an inter-RAT handover. The techniques may be performed, for example, by a multi-mode mobile station capable of communicating with a plurality of different RAT networks.

One example of such a multi-mode mobile station may establish a Voice over Internet Protocol (VoIP) call in a first packet-switched based RAT and may need to hand over to a second packet-switched based RAT while continuing the call. For example, a mobile station may establish a VoIP call in a Worldwide Interoperability for Microwave Access (WiMAX) network and may need to hand over to a Code Division Multiple Access (CDMA) Evolution-Data Optimized (EVDO) network while the call is running

According to current methods for handover, downlink data from a source base station, for example a WiMAX base station, may be very quickly cut off once a downlink data path with a target base station, for example a CDMA EVDO base station, is set up. For example, the downlink data path from the source base station may be cut off once the mobile station sends a Session Initiated Protocol (SIP) Invite packet through the target network.

A network may continue to send VoIP packets to the source base station, even if the downlink data path from the source base station to the mobile station is cut off. This may be due to a time delay, for example, for the network to reroute to the target base station.

Because the mobile station may have already switched to the source RAT, it may be unable to receive downlink VoIP packets transmitted through the source RAT. Thus, the mobile station may not receive VoIP packets in transit through the source RAT once the downlink data path is cut off. Accordingly, aspects of the present disclosure provide methods to avoid downlink packet loss during an inter-RAT handover.

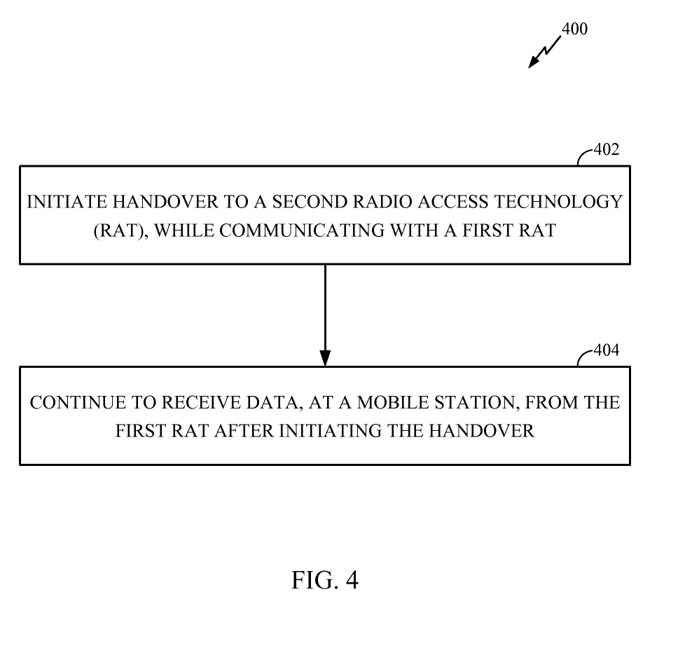

FIG. 4 illustrates example operations 400 which may be performed to avoid VoIP packet loss during an inter-RAT handover. The operations 400 may be performed by a multi-mode mobile station capable of communicating in any number of different RAT networks.

At 402, a mobile station may initiate a handover from a first RAT to a second RAT, while communicating with the first RAT. After initiating the handover, at 404, the mobile station may continue to receive data packets from the first RAT.

As will be described in more detail below, a multi-mode mobile station may utilize first and second receive hardware resources to enhance receiving and to avoid VoIP packet loss during an inter-RAT handover. For example, a mobile station may use second receive hardware resources to continue to receive data from the first RAT after a handover is initiated, while using first receive hardware resources to perform handover operations to the second RAT.

When hybrid automatic repeat request (HARQ) is turned off, a mobile station may use first and second receive hardware resources to avoid downlink packet loss during an inter-RAT handover. According to aspects, a multi-mode mobile station may utilize first and second transmit hardware resources and first and second receive hardware resources in an effort to allow a smooth transition during an inter-RAT handover when HARQ is turned on for the VoIP connection.

A mobile station may begin to exchange handover setup signaling through a base station of a second RAT when an inter-RAT handover is triggered. When message tunneling exists between a base station of the first RAT and a base station of the second RAT, the mobile station may remain in the first RAT for exchanging VoIP packets while exchanging handover messages via tunneling.

When message tunneling does not exist between a base station of the first RAT and a base station of the second RAT, the mobile station may stop transmitting in the first RAT. The mobile station may tune transmit hardware resources to the second RAT while continuously receiving downlink VoIP packets from the first RAT. When a handover is triggered, the mobile station may not be able to transmit or receive VoIP packets in the second RAT.

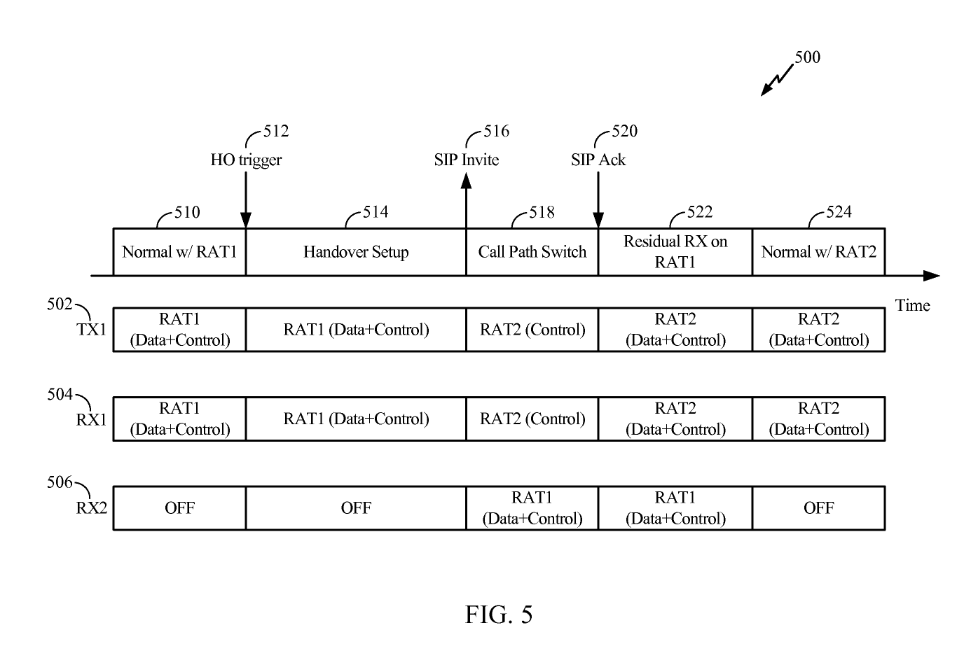

FIG. 5 illustrates an example transmit and receive hardware setup 500 of a multi-mode mobile station with message tunnel for handover without HARQ, according to aspects of the present disclosure.

The mobile station may have first transmit hardware resources 502, first receive hardware resources 504, and second receive hardware resources 506. Initially, at 510, the mobile station may use transmit hardware resources 502 and receive hardware resources 504 to communicate with a first RAT.

At 512, the mobile station may initiate a handover to a second RAT. During handover setup, at 514, the mobile station may use first transmit hardware resources 502 and first receive hardware resources 504 to communicate with the first RAT.

After handover setup is complete, the mobile station may send a Session Initiation Protocol (SIP) signaling packet (SIP Invite) 516 to an Internet Multimedia Service (IMS) network to request a handover to a second RAT.

At 518, during call path switch, the first transmit hardware resources 502 and the first receive hardware resources 504 may transmit and receive control information in the second RAT. During call path switch 518, the mobile station may buffer some uplink VoIP packets. At this time, the mobile station may use second receive hardware resources 506 to continue to receive downlink data packets from the first RAT.

The mobile station may begin packet transmission through the second RAT when it receives a SIP signaling packet (SIP acknowledgment) 520 from the IMS network.

Thus, at 522, the mobile station may use the first transmit hardware resources 502 and the first receive hardware resources 504 to transmit and receive packets in the second RAT. At this time, the mobile station may have some uplink VoIP packets buffered, which the mobile station may immediately transmit in the second RAT after receiving the SIP acknowledgment.

In an effort to avoid downlink packet loss, the mobile station may continue to receive VoIP packets, using the second receive hardware resources 506, from the first RAT for a predetermined period of time until the mobile station may only receive data from the second RAT. After the predetermined period of time has elapsed, the mobile station may, at 524, stop receiving downlink data from the first RAT and may use the first transmit hardware resources 502 and the first receive hardware resources 504 to communicate with the second RAT.

According to aspects, the described methods may avoid almost all packet loss. As illustrated, the hardware setup of FIG. 5 may avoid downlink packet loss during inter-RAT handover by utilizing the first and second receive hardware resources. Uplink VoIP packets may be buffered during call path switch 518 and may be transmitted as soon as the handover is complete.

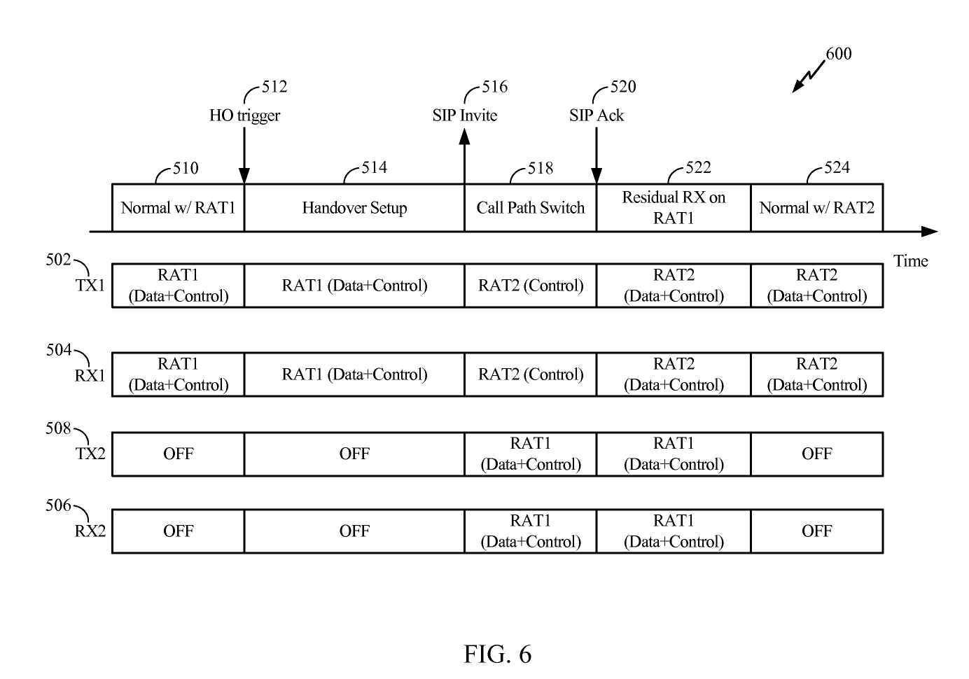

FIG. 6 illustrates an example transmit and receive hardware setup 600 of a multi-mode mobile station with message tunnel for handover with HARQ, in accordance with certain aspects of the present disclosure. Because HARQ is turned on for the VoIP connection illustrated in FIG. 6, the mobile station may use additional transmit hardware resources 508.

During call path switch 518, the mobile station may use the first transmit hardware resources 502 and the first receive hardware resources 504 to transmit and receive control data in the second RAT. Because HARQ is turned on, in addition to using the second receive hardware resources 506 to continue to receive data with the first RAT, the mobile station may use second transmit hardware resources 508 to transmit data with the first RAT.

At 522, after the mobile station receives a SIP acknowledgment 520 from the IMS, the mobile station may start VoIP transmission through the second RAT. According to aspects, the mobile station may use the first transmit hardware resources 502 and the first receive hardware resources 504 to transmit and receive VoIP packets in the second RAT.

The mobile station may also use the second transmit hardware resources 508 and the second receive hardware resources 506 to continue to transmit and receive data in the first RAT for a predetermined period of time until the mobile station may only transmit and receive in the second RAT, thereby avoiding downlink VoIP packet loss.

After the predetermined period of time has elapsed, the mobile station may, at 524, begin normal operations with the second RAT. For example, the mobile station may stop receiving and transmitting data with the first RAT and may use the first transmit hardware resources 502 and the first receive hardware resources 504 to communicate with the second RAT.

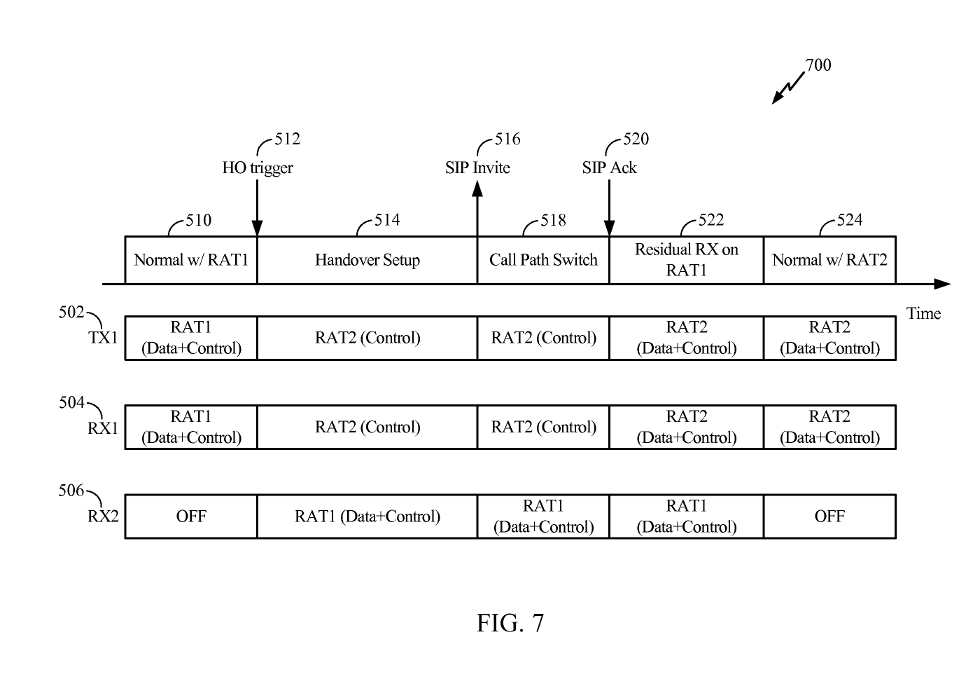

FIG. 7 illustrates an example transmit and receive hardware setup 700 of a multi-mode mobile station without message tunnel for handover without HARQ, according to aspects of the present disclosure.

During a handover without message tunnel between a base station of the first RAT and a base station of the second RAT, the mobile station may stop transmitting in the first RAT. For example, during handover setup 514, the mobile station may tune first transmit hardware resources 502 to the second RAT. According to aspects, the mobile station may not be able to transmit or receive data packets with the second RAT during this time.

As previously described, the mobile station may utilize second receive hardware resources 506 to continue to receive data packets from the first RAT, in an effort to avoid downlink packet loss.

Handover to the second RAT may be complete after the mobile station receives a SIP acknowledgment 520 from the IMS. At 522, the mobile station may use the first transmit hardware resources 502 and the first receive hardware resources 504 to transmit and receive VoIP packets in the second RAT. As well, the mobile station may transmit any buffered uplink VoIP packets in the second RAT.

In an effort to avoid downlink packet loss, the mobile station may use the second receive hardware resources 506 to continue to receive data in the first RAT for a predetermined period of time until the mobile station may only transmit and receive in the second RAT. Normal operations with the second RAT may begin, at 524, once the predetermined period of time has elapsed.

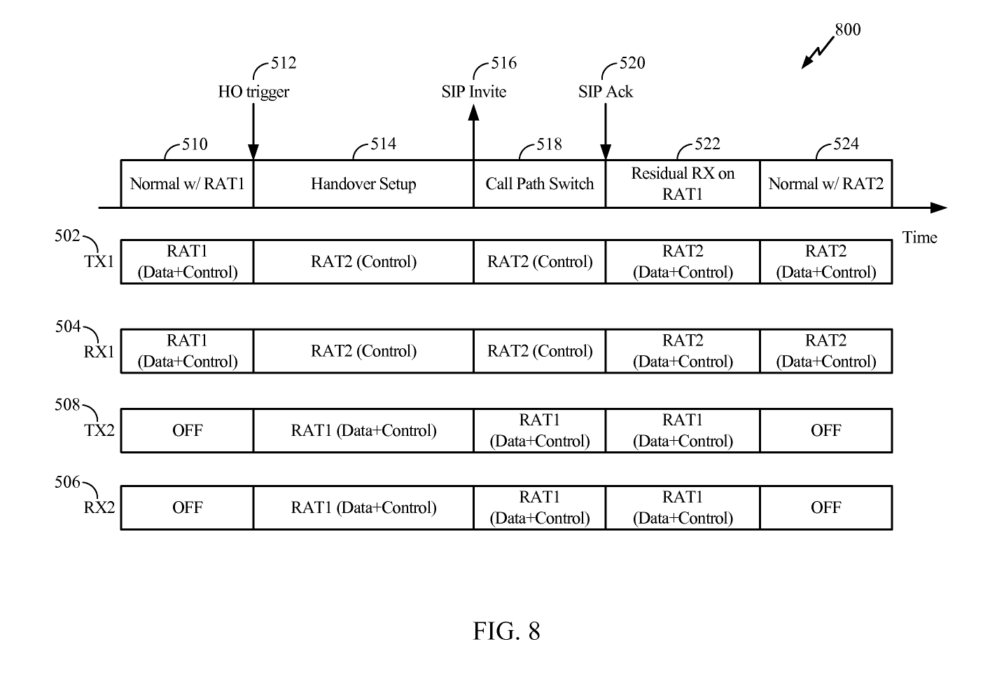

FIG. 8 illustrates an example transmit and receive hardware setup 800 of a multi-mode mobile station without message tunnel for handover with HARQ, according to aspects of the present disclosure. Because HARQ is turned on for the VoIP connection illustrated in FIG. 8, the mobile station may use additional transmit hardware resources 508.

During a handover setup 514 without message tunnel between a base station of the first RAT and a base station of the second RAT, the mobile station continues transmitting in the first RAT. The mobile station may use the first transmit hardware resources 502 and the first receive hardware resources 504 to transmit and receive control data in the second RAT. Because HARQ is turned on, the mobile station may use the second transmit hardware resources 508 in addition to the second receive hardware resources 506 to continue to transmit and receive data with the first RAT.

At 522, after the mobile station receives a SIP acknowledgment 520 from the IMS, the mobile station may start VoIP transmission through the second RAT. According to aspects, the mobile station may use the first transmit hardware resources 502 and the first receive hardware resources 504 to transmit and receive VoIP packets in the second RAT.

The mobile station may use the second transmit hardware resources 508 and the second receive hardware resources 506 to continue to transmit and receive data in the first RAT for a predetermined period of time until the mobile station may only transmit and receive in the second RAT, thereby avoiding downlink VoIP packet loss. After the predetermined period of time has elapsed, the mobile station may begin normal operations, at 524, with the second RAT. During normal operations, the mobile station may use first transmit hardware resources 502 and first receive hardware resources to communicate in the second RAT.

According to aspects, the “OFF” indications illustrated in FIGS. 5-8 may refer to time periods during which respective transmit hardware resources or receive hardware resources are turned off. Alternatively, they may refer to time periods during which uplink and downlink MIMO transmissions occur with a single RAT.

In an effort to reconstruct received VoIP packets, a higher layer at the mobile station, such as a Real-Time Transport Protocol (RTP) may allow packets from the first RAT to play up before VoIP packets from the second RAT play.

As described herein, a multi-mode mobile station may utilize first and second receive hardware resources to enhance receiving and to avoid VoIP packet loss during an inter-RAT handover. According to aspects, a mobile station may use second receive hardware resources to continue to receive data from the first RAT after a handover is initiated, while using first receive hardware resources to perform handover operations to the second RAT.

During handover with HARQ enabled for a VoIP connection, the mobile station may also use first and second transmit hardware resources, in addition to first second receive hardware resources, to improve performance during VoIP inter-RAT handover.

While techniques have been described with reference to particular examples involving WiMAX and CDMA EVDO networks, those skilled in the art will recognize that the techniques presented herein may be more generally applied to avoid packet loss when a multi-mode mobile station performs an inter-RAT handover between any different types of RAT networks.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The various operations of methods described above may be performed by various hardware and/or software component(s) and/or module(s) corresponding to means-plus-function blocks illustrated in the Figures. More generally, where there are methods illustrated in Figures having corresponding counterpart means-plus-function Figures, the operation blocks correspond to means-plus-function blocks with similar numbering.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communication, comprising:
initiating handover to a second radio access technology (RAT), while communicating with a first RAT; and
continuing to receive data, at a mobile station, from the first RAT after initiating the handover.

2. The method of claim 1, wherein:
the first RAT comprises at least one of orthogonal frequency-division multiplexing (OFDM) or orthogonal frequency division multiple access (OFDMA) RAT; and
the second RAT comprises a Code Division Multiple Access (CDMA) RAT.

3. The method of claim 1, wherein continuing to receive data from the first RAT after initiating the handover comprises:
utilizing second receive hardware resources to receive data from the first RAT while performing handover operations to the second RAT utilizing first receive hardware resources.

4. The method of claim 3, further comprising:
utilizing the second receive hardware resources for communicating with the first RAT for a predetermined period of time until the mobile station may only receive data from the second RAT.

5. The method of claim 4, further comprising:
tuning first transmit hardware resources to the second RAT during handover setup.

6. The method of claim 5, further comprising:
tuning second transmit hardware resources to the first RAT during the handover setup.

7. The method of claim 1, wherein initiating the handover comprises:
exchanging handover messages via tunneling between a base station of the first RAT and a base station of the second RAT.

8. An apparatus for wireless communication, comprising:
means for initiating handover to a second radio access technology (RAT), while communicating with a first RAT; and
means for continuing to receive data, at a mobile station, from the first RAT after initiating the handover.

9. The apparatus of claim 8, wherein:
the first RAT comprises at least one of orthogonal frequency-division multiplexing (OFDM) or orthogonal frequency division multiple access (OFDMA) RAT; and
the second RAT comprises a Code Division Multiple Access (CDMA) RAT.

10. The apparatus of claim 8, wherein the means for continuing to receive data from the first RAT after initiating the handover comprises:
means for utilizing second receive hardware resources to receive data from the first RAT while performing handover operations to the second RAT utilizing first receive hardware resources.

11. The apparatus of claim 10, further comprising:
means for utilizing the second receive hardware resources for communicating with the first RAT for a predetermined period of time until the mobile station may only receive data from the second RAT.

12. The apparatus of claim 11, further comprising:
means for tuning first transmit hardware resources to the second RAT during handover setup.

13. The apparatus of claim 12, further comprising:
means for tuning second transmit hardware resources to the first RAT during the handover setup.

14. The apparatus of claim 8, wherein the means for initiating the handover comprises:
means for exchanging handover messages via tunneling between a base station of the first RAT and a base station of the second RAT.

15. An apparatus for wireless communication, comprising:
at least one processor configured to:
initiate handover to a second radio access technology (RAT), while communicating with a first RAT; and
continue to receive data, at a mobile station, from the first RAT after initiating the handover; and
a memory coupled to the at least one processor.

16. The apparatus of claim 15, wherein:
the first RAT comprises at least one of orthogonal frequency-division multiplexing (OFDM) or orthogonal frequency division multiple access (OFDMA) RAT; and
the second RAT comprises a Code Division Multiple Access (CDMA) RAT.

17. The apparatus of claim 15, wherein the at least one processor is configured to continue to receive data from the first RAT after initiating the handover by:
utilizing second receive hardware resources to receive data from the first RAT while performing handover operations to the second RAT utilizing first receive hardware resources.

18. The apparatus of claim 17, wherein the at least one processor is further configured to:
utilize the second receive hardware resources for communicating with the first RAT for a predetermined period of time until the mobile station may only receive data from the second RAT.

19. The apparatus of claim 18, wherein the at least one processor is further configured to:
tune first transmit hardware resources to the second RAT during handover setup and tune second transmit hardware resources to the first RAT during the handover setup.

20. The apparatus of claim 15, wherein the at least one processor is configured to initiate the handover by:
exchanging handover messages via tunneling between a base station of the first RAT and a base station of the second RAT.

21. A computer-program product for wireless communication, the computer-program product comprising a non-transitory computer-readable medium having code stored thereon, the code executable by one or more processors for:
initiating handover to a second radio access technology (RAT), while communicating with a first RAT; and
continuing to receive data, at a mobile station, from the first RAT after initiating the handover.

22. The computer-program product of claim 21, wherein:
the first RAT comprises at least one of orthogonal frequency-division multiplexing (OFDM) or orthogonal frequency division multiple access (OFDMA) RAT; and
the second RAT comprises a Code Division Multiple Access (CDMA) RAT.

23. The computer-program product of claim 21, wherein the code for continuing to receive data from the first RAT after initiating the handover comprises:
code for utilizing second receive hardware resources to receive data from the first RAT while performing handover operations to the second RAT utilizing first receive hardware resources.

24. The computer-program product of claim 21, wherein the code for initiating the handover comprises:
code for exchanging handover messages via tunneling between a base station of the first RAT and a base station of the second RAT.
